(19) United States
(12) Patent Application Publication
(10) Pub. No.: US 2007/0299726 A1
(43) Pub. Date: Dec. 27, 2007

(54) METHODS AND APPARATUS FOR PROVIDING AN INCENTIVE TO LEARNING

(76) Inventor: Salar K. Mirran, Washington, DC (US)

Correspondence Address: RADER FISHMAN & GRAUER PLLC, LION BUILDING, 1233 20TH STREET N.W., SUITE 501, WASHINGTON, DC, 20036, US

(21) Appl. No.: 11/763,661

(22) Filed: Jun. 15, 2007

Related U.S. Application Data
(60) Provisional application No. 60/814,073, filed on Jun. 16, 2006.

(51) Int. Cl. G06Q 30/00

(52) U.S. Cl. 705/14

(57) ABSTRACT

A learning incentive vehicle is implemented to promote learning efforts and fund charitable entities that support learning programs. The learning incentive vehicle may be in the form of a bookmark, gift card, electronic, or the like. It has associated therewith a prescribed value and a charitable reserve, and may be used as an incentive to complete a learning task. When an individual completes the learning task, the individual receives a credit for purchases according to the prescribed value of the learning incentive vehicle, and the charitable reserve is allocated to at least one charitable entity that supports learning programs. An individual may also manage received credit through an online account, wherein the individual selects from available retailers to use credit in the account for purchases. The platform through which such online accounts are provided may assist in the suggestion of additional reading materials, and accommodate networking among individual learners as well as other parties such as retailers, buyers and sellers.

### CROSS REFERENCE TO RELATED APPLICATIONS

This application claims the benefit of previously filed provisional App. Ser. No. 60/814,073, filed on Jun. 16, 2006 and entitled “Bookmark Configured as Learning Incentive Vehicle,” the entire contents of which are hereby incorporated by reference.

### BACKGROUND OF THE INVENTION

1. Field of the Invention

This invention relates generally to learning incentives and more particularly to a learning incentive vehicle that promotes individual learning efforts and funds charitable entities that support children's learning programs.

2. Description of the Related Art

A variety of needs exist across several seemingly unrelated constituencies: retailers need to increase exposure without paying heavy marketing costs; book-sellers need to make book buying and reading more interesting to all consumers; parents and schools need to provide tools to children to learn; children need to embrace learning and reading; and states and localities need help funding literacy programs.

### SUMMARY OF THE INVENTION

The present invention provides a learning incentive vehicle and corresponding methods and apparatus for providing an incentive to learning, with potential benefits to retailers, sellers of the incentive vehicle, administrators of learning programs, children or other “learners”, and charitable organizations. One example provides a simple and attractive incentive vehicle that may be in the form of a bookmark.

According to one aspect, the learning incentive vehicle is implemented to promote individual learning efforts and fund charitable entities that support learning programs. This may involve issuing a learning incentive vehicle (e.g., bookmark, gift card, electronic, etc.) having associated therewith a prescribed value and a charitable reserve. The learning incentive vehicle also may be used as an incentive for a given individual to complete a learning task in association with presentation of the learning incentive vehicle to the given individual. As such, the given individual is provided with a credit for purchases according to the prescribed value in connection with the completion of the learning task. Additionally, the charitable reserve may be allocated to a charitable account for at least one charitable entity that supports learning programs in association with usage of the learning incentive vehicle.

In one example, the credit for purchases corresponds to a retailer identified on the learning incentive vehicle. Consideration may be variously established and distributed. For example, the consideration that a buyer pays for the learning incentive vehicle may be allocated to a seller of the learning incentive vehicle, the retailer identified on the learning incentive vehicle, and the charitable reserve.

Online accounts may also be provided in association with the issuance of learning incentive vehicles, wherein providing the given individual a credit for purchases comprises adding the prescribed value to the online account of the given individual, and wherein the given individual selects from available retailers to allocate the credit for purchases to the selected retailer. Online accounts may also assist in the suggestion of additional reading materials, and may accommodate networking among learners as well as other parties.

The present invention can be embodied in various forms, including business processes, computer implemented methods, computer program products, computer systems and networks, user interfaces, application programming interfaces, and the like.

### BRIEF DESCRIPTION OF THE DRAWINGS

These and other more detailed and specific features of the present invention are more fully disclosed in the following specification, reference being had to the accompanying drawings, in which:

FIG. 1 is a block diagram illustrating an example of an environment in which a learning incentive vehicle platform operates.

FIG. 2 is a diagram illustrating an embodiment of a learning incentive vehicle.

FIG. 3 is a diagram illustrating another example of a learning incentive vehicle.

FIG. 4 is a block diagram illustrating an embodiment of a learning incentive vehicle platform.

FIG. 5 is an event diagram illustrating an example of a process for providing a learning incentive.

### DETAILED DESCRIPTION OF THE INVENTION

In the following description, for purposes of explanation, numerous details are set forth, such as flowcharts and system configurations, in order to provide an understanding of one or more embodiments of the present invention. However, it is and will be apparent to one skilled in the art that these specific details are not required in order to practice the present invention.

According to one embodiment, a learning incentive vehicle (LIV) is provided in the form factor of a bookmark that doubles as a form of gift certificate with any number of different denominations: $0.25, $0.50, $0.75 and $1.00, and others. The LIV has value equal to its face amounts and is redeemable at Retailers, whether online or at brick & mortar locations. The identification of the Retailer may appear on the face of the LIV. Alternatively, the LIV may be applicable to a number of retailers selectable by the recipient. The LIVs may be packaged into individual same-amount packages or “combo packages” of different values that can sell for $5.00, $10.00, $20.00 or other amounts.

The LIVs and corresponding packages are designed, created, printed and distributed by a party operating a corresponding LIV platform (LIVP). The LIVP staff may approach a variety of “Sellers” to induce them to showcase or display the LIVs. A good example of a Seller may be a physical or electronic book seller, but any number of different types of retailers may take the Seller role. Sellers display the LIVs electronically, on retail aisles, by cash registers, on stand-alone display cases or whatever other means are applicable to the Sellers. The LIVP and Sellers may both engage in the marketing and awareness of LIVs.

The LIVs are purchased by Buyers that in turn may distribute the LIVs to individuals whom they would like to reward as an incentive to learning. These individuals are the ultimate recipients of the value represented on the LIVs, and may be referred to as “Learners”. Preferably, the LIVs are provided in conjunction with a task assignment related to reading or other learning activities, wherein the LIV is distributed or activated by the Buyer when the task is confirmed as having been completed. There may be instances where a Buyer is attending to the learning activities of a group of Learners. For example, the Buyer may be a school teacher seeking to provide a rewards program for engaging in reading activities. In those circumstances, the Buyer may also be referred to as an Administrator. These various roles will be further understood in connection with the following description.

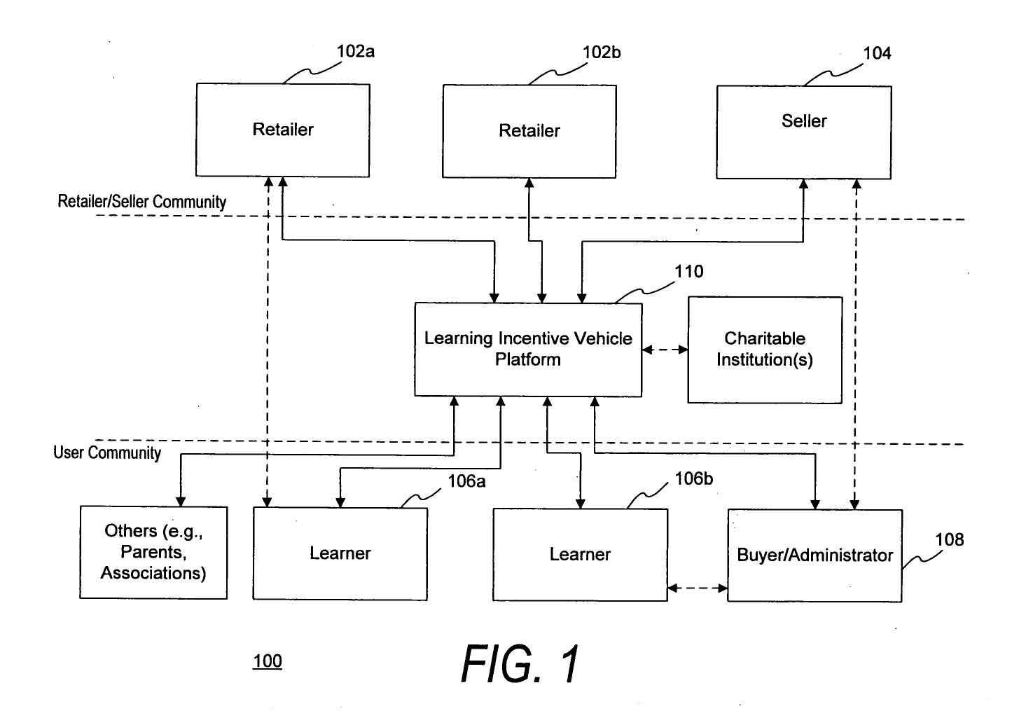

FIG. 1 is a block diagram illustrating an example of an environment 100 in which a LIVP 110 operates. The LIVP 110 is configured to accommodate the activities of issuing, distributing, authenticating, monitoring and otherwise allowing the LIVs to be used as described herein. The LIVP 110 interfaces with Retailers 102a-b, Sellers 104, Buyer/Administrators 108 and Learners 106a-b to facilitate and coordinate their participation in learning incentive programs. In one embodiment the LIVP 110 is an application service provider interfacing with the various participants through a network connection such as the Internet. In that regard, the LIVP 110 comprises computing infrastructure to register and maintain relationships with the participants, carry out the various functions described regarding the implementation and usage of the LIVs, and store necessary information. The participants 102-108 may variously interface with the LIVP 110 using corresponding computing infrastructure and software such as a browser equipped to navigate to and interface with the LIVP 110 to exchange information.

The LIVP 110 is a space where various communities may interact and network, with the common thread of reading or other learning activities (e.g., a math group). For example, the LIVP 110 may network Learners together, individually or in groups. For example, Learners who share an affinity for a book or series of books (e.g., Harry Potter) may connect through the LIVP 110 to engage with other Learners having common interest. Additionally, Retailers may be networked to Sellers and/or Buyers. Thus a Retailer may engage appropriate Sellers for a given promotional program. Alternatively, a Retailer may engage directly with Buyer(s), omitting the Seller. Thus, for example, a school district may engage with a local supermarket to run a learning incentive program (and fundraiser) through the LIVP 110. Still further, the LIVP 110 is a useful platform for gathering information about Learners, Retailers, Sellers, Parents, and/or Buyers so that information can be efficiently targeted to appropriate groups, and so that any of these groups may network for social and/or business purposes.

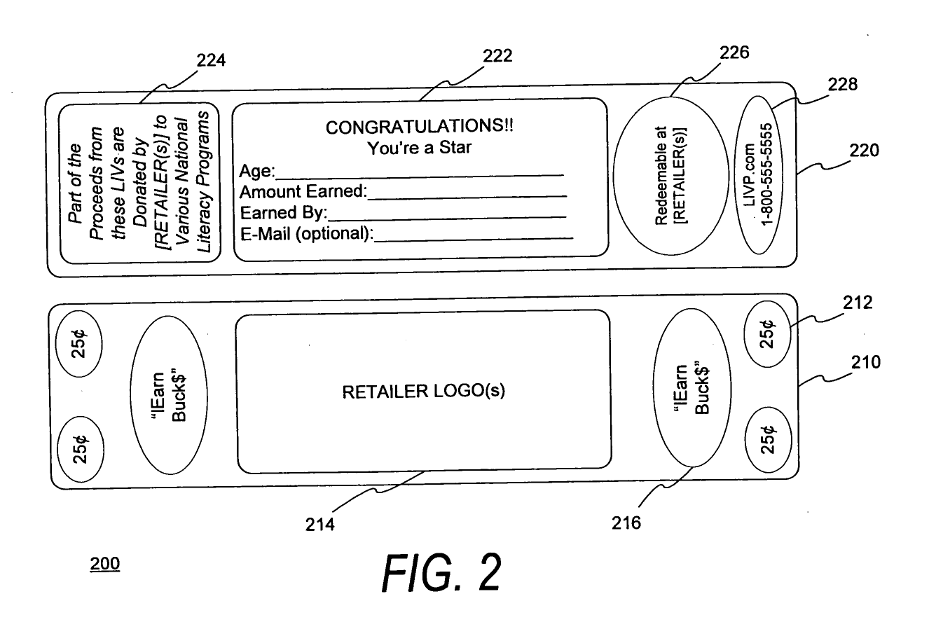

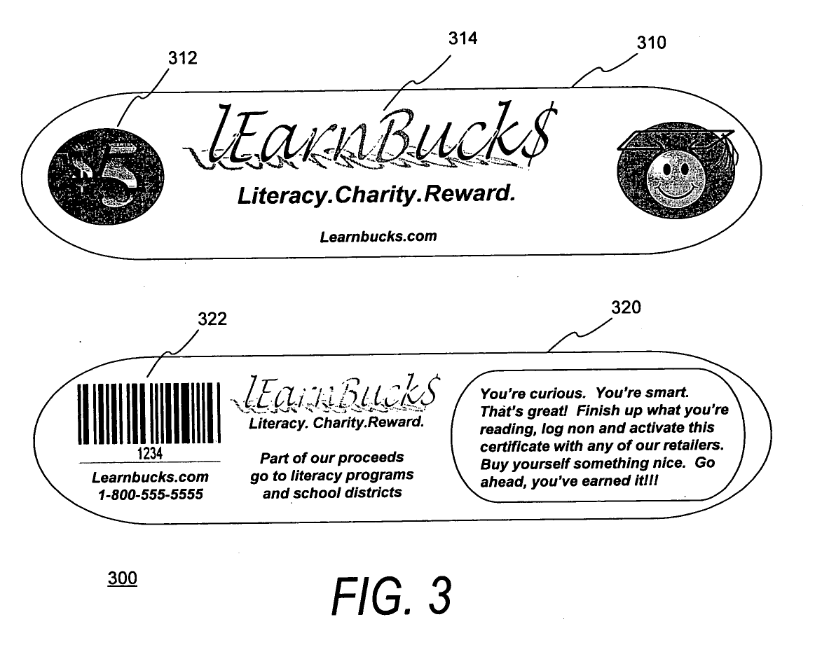

Two examples of LIVs are described further below with reference to FIG. 2 and FIG. 3. In the first example, the LIV has the name of the Retailer provided thereon. In a second example, the LIV does not necessarily have the name of the Retailer specifically noted on it.

The LIV may be purchased by the Buyer and given to the Learner in association with the completion of a learning task. The following description of this scenario is merely an example to illustrate how the LIVs provide a learning incentive that benefits the various parties. It is also noted that the procedure may in whole or in part be carried out online. That is, in lieu of having the first type of LIV, wherein the Learner simply takes the LIV to the noted Retailer, the Buyer/Administrator may manage the learning activities of the Learners, and the Learners accumulate, manage and spend the value they receive through an online interface with the LIVP.

Buyers may purchase the LIVs within whatever mechanism is provided by the Sellers and/or LIV staff. Buyers present the LIVs to the parties (Learners) they wish to induce to further explore academic or other areas of personal development. Learners may hold an individual LIV during the exercise of the task of personal development and earn the right to keep and redeem it upon completion of that task. Buyers may variously engage with Learners regarding the assignment and completion of the learning task. In a simple situation, the Buyer may merely use the LIV as a reward following the completion of the task. Where the Buyer and Learners engage the LIVP online, the task management may be automated and reviewable by both the Buyer and the Learner. In one example, the Buyer may be a teacher who manages a list of Learners, indicating to the LIVP when a given Learner has completed a given task. The LIVP updates the status of the corresponding Learner's LIV(s) accordingly, perhaps by allocating value to the Learner's account for a given LIV when the teacher reports the completion of a corresponding task. Alternatively, the LIVP may be configured to engage with the Learner to carry out the learning task. In this fashion, the Learner may review what is required on the LIVP and perform what is requested, whereupon the LIVP would provide some indication that the Learner has been successful, etc.

Learners have the opportunity to redeem that LIV according to the requirements of the distribution model and the form of the LIV. Generally, redemption allows for the exchange of the LIV by the Learner for a product or service offered by the Retailer in its normal course of business. For example, where the LIV is in the form of a bookmark, the Learner may hand the bookmark to the Retailer to enjoy the benefit of the associated credit. In the example where the LIV is a gift card, the Retailer processes the LIV as would be the case with a Retailer-specific gift card or a credit-based gift card. The result is payment for goods and services to the Retailer and a receipt of goods and services by the Learner. Finally, where the LIV is used online in connection with the LIVP, the value may go into a Learner account that may be used with a variety of retailers.

At some point, the LIVP staff effectuates the distribution of the charitable amounts set aside by the LIVP. The set asides are preferably organized according to Retailers or groups of Retailers indicating a desire to donate to a given charitable organization. The Retailer would direct the LIVP staff in terms of the allocation of those amounts on an annual basis. Recipients of those amounts could be announced publicly, with the donated amounts co-presented by LIVP and the Retailer in a ceremony. A Retailer may choose to carry-over amounts from year to year, pay all amounts to one recipient or distribute the amounts in whatever frequency and distribution profile it wishes.

Various compensation models may apply, such as one where the consideration paid by Buyers in exchange for the LIVs is forwarded to the Retailer who is the subject of that LIV (i.e., printed on face of bookmark) at the time of usage, less whatever concession is negotiated to be paid for the purposes of: (i) compensating the Seller, (ii) compensating the LIVP, and (iii) establishing reserves for charitable literacy projects. Items i and ii are executed in a fashion similar to processing gift certificates or coupons. In fact, the LIV itself may also be in the form of a gift card. The LIVP establishes and maintains the reserves that are ultimately distributed to charitable institutions.

Another compensation model, potentially more appropriate where the LIV does not necessarily identify a specific Retailer on its face, and where the parties engage with the LIVP to further usage of the LIVs, is as follows. When the Buyer purchases the LIVs (e.g. directly from the LIVP), funds for that purchase immediately go into an electronic account of the LIVP. If there is a Seller involved, then the Seller may also withhold a percentage of the sale, or the LIVP and Seller may negotiate whatever form and timing of Seller compensation is desired. The Buyer then distributes the LIVs to Learners as described. In association with the completion of tasks, Learners may then accrue value from each LIV that is flagged as corresponding to the balance maintains in the Learner's online “account”. The Learner may ultimately select a Retailer and purchase something from the Retailer, whereupon the Learner's account balance is used for the purchase, and funds are transferred from the electronic account of the LIVP to the Retailer. Again, the compensation model may have various options, including one where the LIVP retains a fee for referring the Learner to the Retailer for the purchase. According to this model, the LIVP compensation may include the carry occurring between the time of purchase of the LIVs by the Buyer and the actual purchases made with the LIVs.

As mentioned, the LIVs may take on a variety of forms. FIG. 2 is a diagram illustrating an embodiment of a LIV 200 wherein the LIV is preferably in the form of a bookmark, having a front side 210 and a back side 220.

This example of an LIV 200 may be designed to have a look vaguely resembling local (e.g., United States) currency, with the value of the currency being displayed 212. The front side 210 also includes the LIVP logo 216 (or a corresponding trademark for the LIV, such as lEarnBuck$), as well as the logos of one or more retailers (214).

On the back side 220, the LIV 200 may include a prominent display area 222 wherein the Learner may be identified and praised. Additional information may also be included. The back side 220 also includes display areas for a statement regarding certain of the proceeds being set aside for literacy programs 224, an additional reference to the corresponding Retailer(s) 226, and identification and related contact information for the LIVP 228.

With the example of FIG. 2, the Buyer may easily purchase LIVs in a variety of values, and administer them to Learners in connection with their completion of assigned tasks. The Learners may then take the LIVs to the denoted Retailer(s) and use them to make purchases as described.

As described above, the distribution and implementation of the LIVs may also be carried out online, by having the various parties interface with the LIVP through an Internet connection. FIG. 3 is a diagram illustrating another example of an LIV 300, which may be more suitable for embodiments where online management and activation are implemented. The LIV 300 similarly includes front 310 and back 320 sides, but may optionally omit Retailer designation, as such may be more appropriately managed online. Instead, perhaps, the logo of the LIVP may be more prominently displayed (314). Also similar to the previous example is some type of designation, on the LIV 300, of the denomination (312). This allows the LIV 300 to similarly accommodate the sense of immediate gratification that a Learner may receive when presented with the LIV 300. The back side 320 of the LIV 300 also preferably includes an identifier, such as a bar code. The identifier may serve to variously identify the LIV 300 in furtherance of the management of its implementation and usage. One or more unique identifier(s) on the LIV may uniquely identify: the particular LIV 300; a particular LIV 300 denomination; a particular batch of LIVs 300 being used by an administrator/buyer; those LIVs 300 corresponding to particular retailers; those LIVs 300 issued to a particular Seller; etc.

With online embodiments, a variety of activities may be carried out alternatively. For example, the Learner may submit the LIV to the Retailer or to go online to “activate” a received LIV. Upon online activation, the Learner can select a retailer from whom to buy items. Selection may be made from a list of Retailers who have registered with the LIVP. With this option, the Learner can buy directly online from the selected retailer, or submit the activated LIV physically at the store. Alternatively, once they activate, they can build up an online account [like a debit card] to use later. In conjunction with interfacing with the LIVP to activate and manage their account, the LIVP could also collect information about the Learner regarding reading materials, likes/dislikes, reviews, etc. The LIVP could also allow Learners to form a network based upon similar likes, etc.

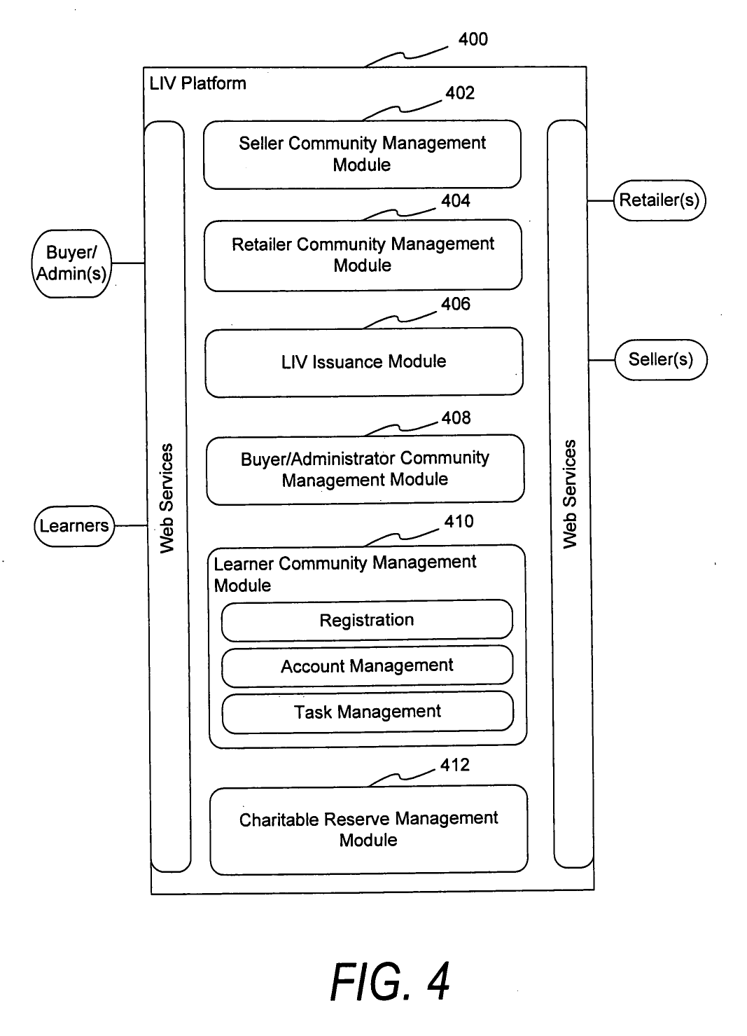

FIG. 4 is a block diagram illustrating an embodiment of an LIVP 400 configured to interface with the various parties. The LIVP 400 rides on a conventional computing platform. It is preferably provided as software, but alternatively may comprise hardware, firmware, or any combination of software, hardware, and/or firmware. It is also noted that, although one modularization of the LIVP 400 is illustrated, the described functionality may be performed by fewer, greater, or differently named modules.

The LIVP 400 includes a seller community management module (SCMM) 402, a retailer community management module (RCMM) 404, an LIV issuance module 406, a buyer/administrator community management module (BCMM) 408, a learner community management module (LCMM) 410, and a charitable reserve management module 412.

The SCMM 402 is configured to register and interface with LIV Sellers. The Sellers navigate to the LIV Platform 400 and register therewith. Registration may be accomplished through online forms and related collection of information, or may involve LIVP staff and related “offline” approvals. Retailers may also separately provide approval or provide a pre-approved list of Sellers for any LIVs to which they will have an association.

Once the Seller is approved and registered, the Seller uses the LIVP 400 to order LIVs that may be physically shipped to the Seller, or that may be printed or otherwise produced by the Seller based upon information provided by the LIVP 400. In addition, the LIV may be provided in electronic form. Preferably, the LIVs have associated therewith unique identifier(s) (e.g., in the form of one or more bar codes) useful for future accounting with regard to their usage, Seller productivity and the like.

The RCMM 404 similarly manages the participation of Retailers. In one embodiment, the Retailer may register in connection with the issuance and usage of Retailer-specific LIVs. This will allow the Retailer to accurately manage the value represented in LIV distributions from the LIVP 400. As mentioned, the Retailer may also approve Sellers and, accordingly, the amount of LIVs distributed to such Sellers. It should be noted that the Seller participation may be considered optional. There may be programs where there is no offline sales component, or there may be programs where Retailer engages as “Seller” for all LIVs having the Retailer identified thereon.

In addition to the above-described participation, the Retailer may provide approval for LIV distributions that are not retailer-specific. As described, in these circumstances the LIV may be used in connection with online account management, wherein retailers are selected from lists by consumers (Learners). A batch of these types of LIVs may be cross-correlated to retailers that have given their approval to be selected, with the unique identifier(s) on the LIVs again serving to allow them to be tracked for such purposes.

The LIV issuance module 406 manages the distribution of LIVs and, accordingly, interfaces with the SCMM 402 and RCMM 404 to carry out necessary marking and cross correlation of the LIVs to Sellers and Retailers. The LIV issuance module 406 is preferably accessible to LIVP 400 staff for the carrying out of administrative functions and the monitoring of LIV distribution. This allows them to expedite distribution and to answer questions that various community members may have regarding LIV distributions or other issues.

The BCMM 408 is optional and allows buyer/administrators to oversee learning activities and corresponding usage of the LIVs. In certain circumstances, a Buyer may merely purchase LIVs and distribute them to Learners as desired, without a detailed organization of that distribution. In other circumstances, the Buyer may want to organize the distribution of learning tasks and LIVs to Learners. For example, a teacher or school may have a reading program wherein they want to use LIVs. The teacher may want to retain control over whether and how LIVs are used, and may want to oversee the progress of individual Learners. The BCMM 408 allows the teacher to have a portal through which the reading program is managed. To accommodate this, the BCMM 408 allows the teacher (aka Buyer/Administrator) to input the names of students who may receive LIVs in connection with the reading program. Interfaces also allow the teacher to review (or provide input confirming) whether students have completed certain tasks in that regard. Optionally, the BCMM 408 allows the teacher to use the identifier code(s) on the LIVs to associate them with particular students, so that the distribution of the LIVs can be further organized and tracked by the teacher.

The LCMM 410 allows Learners to register with the LIV Platform 400 and to activate their LIVs online. This allows the Learner to establish a unique account that they can navigate to, wherein they can accumulate LIV value and save it for purchases at participating retailers. The LCMM 410 includes registration, account management and task management components.

Registration may be accommodated through conventional online forms and corresponding user interfaces. If desired, the registration of Learners may be contingent on invitation from an approved entity, such as a teacher or other Buyer/Administrator. In this regard, the approved entity may e-mail a token to the Learner, which may then be used to link to a web page wherein approved registration is commenced.

The account management component provides interfaces for and allows the Learner to manage their LIV account value. It may list accrued and pending value, with the latter being designated as becoming available whenever corresponding tasks are completed by the Learner. It may further identify corresponding retailers in association with all of the accumulated value, or subsets thereof if appropriate. The account management component may also manage a listing of materials that have been read as completion of learning tasks associated with learning incentive vehicles. In that regard, additional reading suggestions can be made based upon the listed materials. If desired, third party online booksellers may be engaged to acquire information about possible desirable selections, of the LIVP may independently hold and maintain such information based upon feedback from the community of learners.

Additionally, as noted previously, the LIVP may become a space wherein Learners may network together based upon common interests or the like. In that regard, the LIVP may be configured to connect those Learners who have indicated particular enjoyment of a given book, group of books, genre. Other factors may be reviewed as well, including age, gender, location, etc. to establish well-tailored groups of common interest. All of this information may be uniquely gathered by the LIVP as the platform for the learning experience.

The task management component may list the tasks that are pending and which require completion, as well as a history of completed tasks. This, for example, may provide a listing of books that the Learner has read during the course of the reading program. The task management component may also interface with a suggestion engine, which may suggest additional books based upon the books that the Learner has read, an indication of which books the Learner has enjoyed, etc.

The Charitable Reserve Management Module 412 provides management of the reserves set aside from LIV purchase and usage. The module 412 may interface with other modules in a restricted fashion, for example to allow a retailer to review how much charitable contribution has accumulated in connection with their participation. As described above, the reserves may be held in trust, with regular reporting to the retailer and perhaps the charitable institution, with the money eventually being distributed to the charitable institution on a periodic basis, such as once per quarter or once annually.

It should be noted that various options for selecting charities may be implemented. For example, the charitable reserve and ultimate donation may be entirely governed by the LIVP, entirely governed by the Retailer, entirely governed by the Buyer, or governed by any combination of the LIVP, Retailer and/or Buyer.

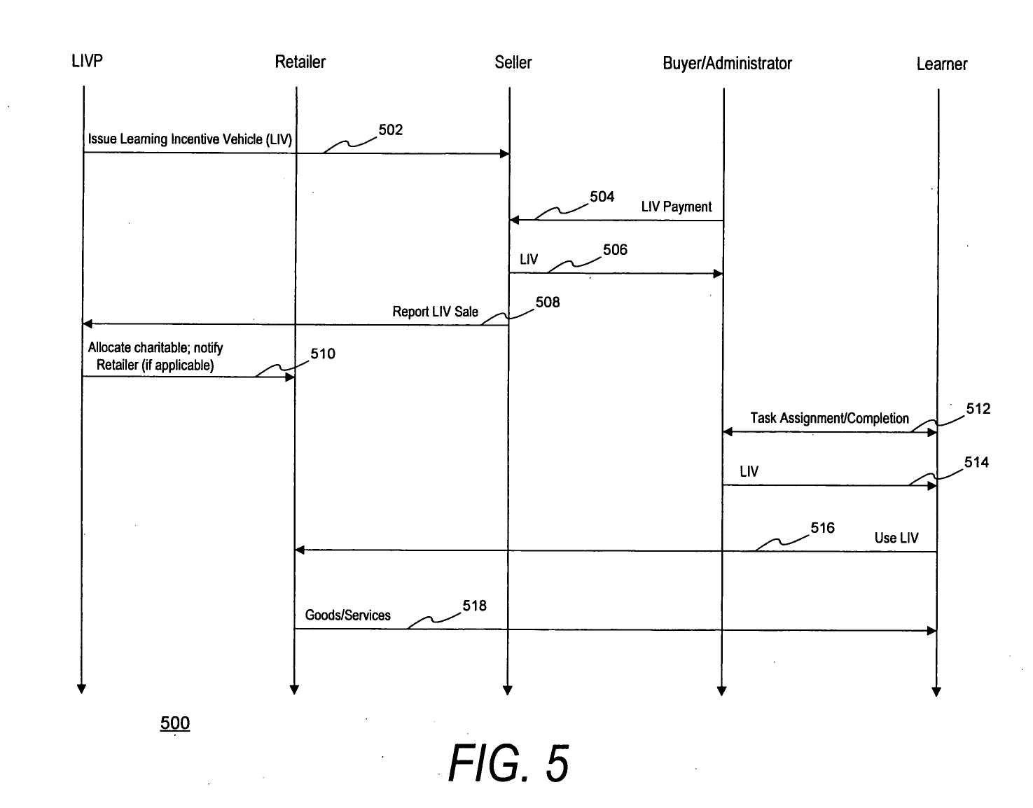

FIG. 5 is an event diagram illustrating an example of a process 500 for providing a learning incentive. Generally, the process entails issuing an LIV having associated therewith a prescribed value and a charitable reserve, wherein the learning incentive vehicle is used as an incentive for a given individual to complete a learning task in association with presentation of the learning incentive vehicle to the given individual; providing the given individual a credit for purchases according to the prescribed value in connection with the completion of the learning task; and allocating the charitable reserve to a charitable account for at least one charitable entity that supports learning programs in association with usage of the learning incentive vehicle.

The illustrated process 500 may commence with the distribution 502 of the LIVs. As explained above, LIVs may be variously distributed, such as to Sellers, directly to Buyer/Administrators, or by making them generally available on the LIVP as described above. For ease of illustration and discussion, the instance where the LIVs are issued to the Sellers is depicted.

The Buyer may then purchase the LIVs by making a payment 504 to the Seller in exchange for the LIVs 506 as is done in most typical retail exchanges. Of course, as described in detail above, various compensation models may apply, and indeed the Seller may be omitted such that compensation goes to the LIVP. Continuing with the example, the Seller reports (ad hoc, or in batch) 508 the LIV sale to the LIVP. This allows the LIVP to allocate 510 the appropriate funds to the charitable reserve, and to notify the retailer with regard to the sale (for purposes of tracking their charitable contribution amounts and/or outstanding credit or pre-paid purchases as accounting needs dictate).

The Buyer/Administrator then engages 512 with Learner(s) in order to distribute the LIVs and to associate desired learning tasks with their distribution and redemption. As describe above, the LIV may be given 514 to the Learner following completion of a task, or may have a pending task associated therewith, where the user must complete the task to activate the value in the LIV. The Learner then uses 516 the LIV in the same fashion that a gift card or certificate is used, to purchase 518 goods or services from the named or selected retailer.

Thus embodiments of the present invention produce and provide learning incentive vehicle that promotes individual learning efforts and funds charitable entities that support learning programs. Although the present invention has been described in considerable detail with reference to certain embodiments thereof, the invention may be variously embodied without departing from the spirit or scope of the invention. Therefore, the following claims should not be limited to the description of the embodiments contained herein in any way.

1. A method for implementing a learning incentive vehicle that promotes individual learning efforts and funds charitable entities that support learning programs, the method comprising:
issuing a learning incentive vehicle having associated therewith a prescribed value and a charitable reserve, wherein the learning incentive vehicle is used as an incentive for a given individual to complete a learning task in association with presentation of the learning incentive vehicle to the given individual;
providing the given individual a credit for purchases according to the prescribed value in connection with the completion of the learning task; and
allocating the charitable reserve to a charitable account for at least one charitable entity that supports learning programs in association with usage of the learning incentive vehicle.

2. The method of claim 1, wherein the credit for purchases corresponds to a retailer identified on the learning incentive vehicle.

3. The method of claim 2, wherein consideration that a buyer pays for the learning incentive vehicle is allocated to a seller of the learning incentive vehicle, the retailer identified on the learning incentive vehicle, and the charitable reserve.

4. The method of claim 1, further comprising:
providing online accounts in association with the issuance of learning incentive vehicles, wherein providing the given individual a credit for purchases comprises adding the prescribed value to the online account of the given individual, and wherein the given individual selects from available retailers to allocate the credit for purchases to the selected retailer.

5. The method of claim 1, further comprising:
providing online accounts in association with the issuance of learning incentive vehicles, wherein individuals list materials that have been read as completion of learning tasks associated with learning incentive vehicles, and wherein additional reading suggestions are made based upon the listed materials.

6. A system for implementing a learning incentive vehicle that promotes individual learning efforts and funds charitable entities that support learning programs, the system comprising:
means for issuing a learning incentive vehicle having associated therewith a prescribed value and a charitable reserve, wherein the learning incentive vehicle is used as an incentive for a given individual to complete a learning task in association with presentation of the learning incentive vehicle to the given individual;
means for providing the given individual a credit for purchases according to the prescribed value in connection with the completion of the learning task; and
means for allocating the charitable reserve to a charitable account for at least one charitable entity that supports learning programs in association with usage of the learning incentive vehicle.

7. The system of claim 6, wherein the credit for purchases corresponds to a retailer identified on the learning incentive vehicle.

8. The system of claim 7, wherein consideration that a buyer pays for the learning incentive vehicle is allocated to a seller of the learning incentive vehicle, the retailer identified on the learning incentive vehicle, and the charitable reserve.

9. The system of claim 6, further comprising:
means for providing online accounts in association with the issuance of learning incentive vehicles, wherein providing the given individual a credit for purchases comprises adding the prescribed value to the online account of the given individual, and wherein the given individual selects from available retailers to allocate the credit for purchases to the selected retailer.

10. The system of claim 6, further comprising:
means for providing online accounts in association with the issuance of learning incentive vehicles, wherein individuals list materials that have been read as completion of learning tasks associated with learning incentive vehicles, and wherein additional reading suggestions are made based upon the listed materials.

11. An apparatus for implementing a learning incentive vehicle that promotes individual learning efforts and funds charitable entities that support learning programs, the apparatus comprising:
an LIV issuance module, for issuing a learning incentive vehicle having associated therewith a prescribed value and a charitable reserve, wherein the learning incentive vehicle is used as an incentive for a given individual to complete a learning task in association with presentation of the learning incentive vehicle to the given individual;
a learner account management module, for providing the given individual a credit for purchases according to the prescribed value in connection with the completion of the learning task; and
a charitable reserve management module, for allocating the charitable reserve to a charitable account for at least one charitable entity that supports learning programs in association with usage of the learning incentive vehicle.

12. The apparatus of claim 1, wherein the credit for purchases corresponds to a retailer identified on the learning incentive vehicle.

13. The apparatus of claim 12, wherein consideration that a buyer pays for the learning incentive vehicle is allocated to a seller of the learning incentive vehicle, the retailer identified on the learning incentive vehicle, and the charitable reserve.

14. The apparatus of claim 11, wherein the learner account management module provides online accounts in association with the issuance of learning incentive vehicles, wherein providing the given individual a credit for purchases comprises adding the prescribed value to the online account of the given individual, and wherein the given individual selects from available retailers to allocate the credit for purchases to the selected retailer.

15. The apparatus of claim 11, wherein the learner account management module provides online accounts in association with the issuance of learning incentive vehicles, wherein individuals list materials that have been read as completion of learning tasks associated with learning incentive vehicles, and wherein additional reading suggestions are made based upon the listed materials.
